(19) United States
(12) Patent Application Publication
(10) Pub. No.: US 2008/0235071 A1
(43) Pub. Date: Sep. 25, 2008

(54) Automatic Generation of Personalized Meeting Lists

(75) Inventors: Srinivas Gutta, Eindhoven (NL); Wilhelmus Franciscus Johannes Verhaegh, Eindhoven (NL); Petrus Gerardus Meuleman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/597,284

(22) PCT Filed: Jan. 17, 2005
(86) PCT No.: PCT/IB05/50188

§ 371 Date: Jul. 19, 2006

(51) Int. Cl. G06Q 10/00; G06F 15/16

(52) U.S. Cl. 705/9; 709/203

(57) ABSTRACT

A method and system for providing a personalized list of meetings per subject per user of the system (1), includes a system computer (4) and user computer (12) each configured for bidirectionally communicating over the Internet (8), whereby the system computer (4) is programmed to first obtain either explicitly (20) or implicitly (26) a profile listing various meeting preferences of a user, to next obtain a list of future meetings corresponding to at least a portion of the user's profile, followed by sending the user the list of recommended meetings generated, along with location specific information if requested by the user.

This Application is related to Ser. No. 09/466,406, entitled “Method And Apparatus For Recommending Television Programming Using Decision Trees,” filed on Dec. 17, 1999; to publication US000239, Ser. No. 09/666,401, entitled “Method And Apparatus For Generating Recommendation Scores Using Implicit And Explicit Viewing Preferences,” filed on Sep. 20, 2000; and to publication US010128, Ser. No. 09/953,385, entitled “Four-Way Recommendation Method And System Including Collaborative Filtering,” filed on Sep. 10, 2001. These related Applications are assigned to the same assignee of the present Application, and the teachings thereof are incorporated herein by reference to the extent that they do not conflict herewith.

The field of the present invention relates generally to the scheduling of future conferences/symposiums/seminars and other such meetings. More particularly, the present invention relates to a method and apparatus for providing personalized lists of meetings to respective users.

In any given year hundreds of conferences/symposiums/seminars/educational courses, and other such meetings are typically organized on a subject basis. Presently, individuals who may wish either to enroll in a particular scheduled meeting as previously enumerated, or who may wish to submit material for a presentation at a particular meeting, can only become aware of a meeting of interest if they have been previously placed on a mailing list for meetings of interest, or to accidentally learn of a particular meeting through word-of-mouth, or by conducting computerized search on the Internet for such meetings of interest. As a result, such individuals have to periodically conduct a research to determine new meetings that have been announced since a last research effort, and to obtain information as to where such meetings will be held, paper submission deadline dates if of interest, the cost to participate, chairperson of the conference, and other relevant information. Presently, it is extremely difficult, if not impossible for an individual to keep track of meetings of interest as they are announced, and to determine on some rating scale the level of interest that the individual may have in a particular newly announced meeting. Accordingly, there is a long felt need in the art for methods and/or apparatus operative to permit individuals to obtain a listing of meetings tailored to individuals preferences.

The present invention provides means for obtaining a profile of the preferences of each respective user relative to meetings that may be of interest to the user. Such information can be obtained over the Internet via a computerized provider system querying and/or requesting a user to provide their preferences. Upon obtaining such information, a provider system can then automatically form a profile for the associated user, employ the profile for searching on the Web for events or meetings matching the profile of the user, assemble the same, and present the listing of event or meeting recommendations fitting the profile to the user. The provider system can obtain information for the profile either explicitly by having the user directly provide the information; or implicitly via observation of the user's activities on the Internet relative to the types of events, meetings, conferences and so forth the user prefers; or by combining previously obtained explicit and implicit profiles. Also, rather than search the Web for meetings corresponding to the profile, collaborative filtering can be employed by matching the user's profile against preference information of other users, for recommending a listing of meetings, based upon what other users have preferred who have similar interests to the user. In broad terms, the present invention or system provides a personalized list of meetings per subject per user based on the user's preferences.

Various embodiments of the present invention are described in detail below with reference to the drawings, in which like items are identified by the same reference designation, wherein:

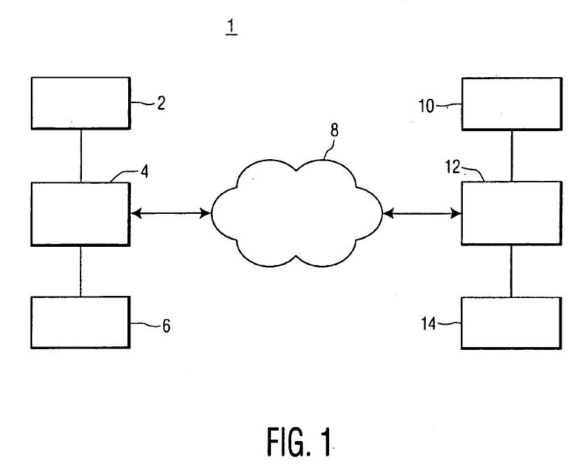

FIG. 1 is a simplistic block diagram of basic hardware and software required in the system 1, and required by a user, by directionally communicating over the Web or Internet;

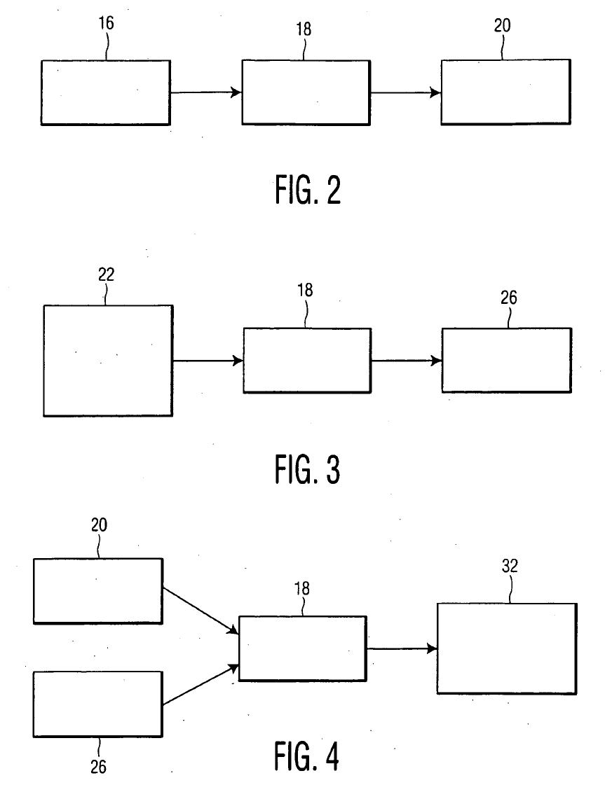

FIG. 2 is a block diagram of one embodiment of the invention for obtaining an explicit user profile;.

FIG. 3 is a block diagram of another embodiment of the invention for obtaining an implicit user profile;

FIG. 4 is a block diagram showing an embodiment of the invention for obtaining an user profile from previously obtained explicit and implicit profiles of the user;

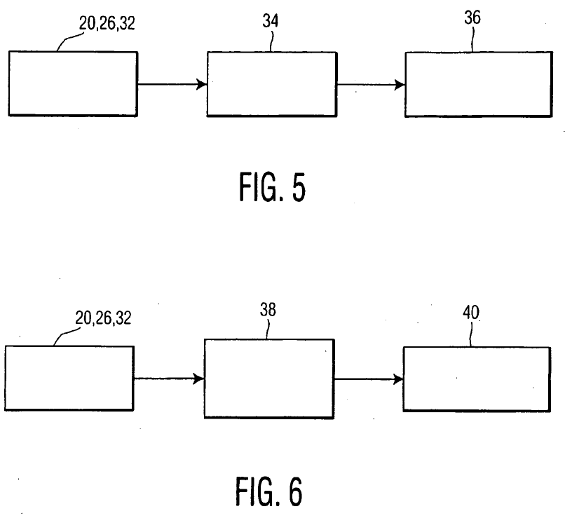

FIG. 5 is a block diagram of one embodiment of the invention for generating meeting recommendations by conducting a search on the Web for meetings based upon a previously obtained user profile;

FIG. 6 shows a block diagram for another embodiment of the invention for obtaining meeting recommendations based upon a user profile and collaborative filtering; and

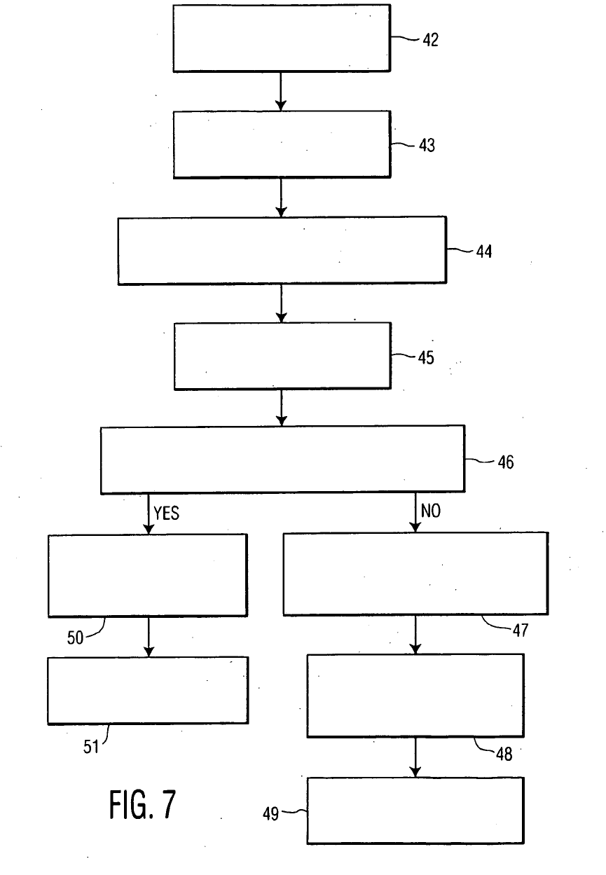

FIG. 7 is a flowchart for an embodiment of the invention showing the steps for generating meeting recommendations for supply to a given user.

With reference to FIG. 1, the present system 1 includes the use of any programmable computer capable of bidirectionally communicating over the Web or Internet with a plurality of users, typically on a one-to-one basis. The system computer 4 typically includes a monitor 2, and software 6 for programming the computer 4 to provide the required functions. Similarly, each user, for bidirectionally communicating over the Internet or Web with the system computer 4, requires a user computer 12 including a monitor 10, and software 14 providing programming of the computer 12 in a standard or known operating configuration. No special software 14 is required for programming the user computer 12. A typical user 12, in order to obtain a personalized meeting list, on either a one-time or subscription basis, simply communicates with the present system 1 over the Internet 8, fills out an online application form, and pays a required fee. As with most Internet providers of various services, the user will typically be provided an identification number, and a personalized password or security code. After completing the enrollment phase, the user can then have the system 1 generate a personalized meeting list for the user's consideration via the methodology described below for the various embodiments of the present invention.

In a first embodiment of the invention, as shown in FIG. 2, upon receiving a request from a user computer 12 for a personalized meeting list, the system computer 4 is programmed to send a menu to the user 12 for prompting the user to provide their preferences for various topics associated with meetings of interest. For example, with reference to various meetings, the user will be prompted to provide a prioritized listing of their preferences based upon the following associated meeting information which the system computer 4 is programmed to present in the form of perhaps questions relative to the following:

1. Subject areas for meetings of interest;

2. Location or geographic area;

3. Day or dates;

4. Duration and time schedules;

5. Cost of enrollment;

6. Organizer's name;

7. Names of instructors;

8. Subject area keywords;

9. Special Discounts;

10. Invited speakers;

11. Frequency of sponsor organization for holding meeting(s)

12. Deadline for submitting papers;

13. Percentage of papers accepted by organizer;

14. Sponsoring organizations, and so forth.

With further reference to FIG. 2, upon receiving the user provided preferences 16, the system profiler 18 processes the user provided preferences 16 to generate an explicit user profile 20. In this embodiment the user has, as indicated, explicitly provided their preferences for profile information to the system 1.

In another embodiment of the invention, as shown in FIG. 3, for a given user, an implicit user profile is obtained by the system profiler 18, via programming of the system computer 4 for monitoring the particular user's Website activities associated with meetings that the user prefers. For example, the system computer 4 can be programmed for running system monitoring 22 to observe Websites the user contacts for reviewing meeting related information. The system monitoring 22 will then gather information about the meetings based upon the above-listed preference topics to assemble an implicit user profile 26. The system profiler 18 is programmed to automatically create the implicit user profile 26. Note that implicit and explicit obtainment of user profiles 20 and 26, respectively, for activities remote from the generalization of personalized meeting lists, but as indicated related to implicit and explicit information gathering, is taught in the previously cited related applications. Specifically in Ser. No. 09/466,406, for “Method And Apparatus For Recommending Television Programming Using Decision Trees,” filed Dec. 17, 1999, teaches the use of implicit profiling. Also, Ser. No. 09/666,401, for “Method And Apparatus For Generating Recommendation Scores Using Implicit and Explicit Viewing Preferences,” filed Sep. 20, 2000, teaches both implicit and explicit profiling. However, such profiling is for a completely different purpose than that of the present invention. Also as previously indicated, the teachings of these references are incorporated herein by reference to the extent they do not conflict herewith.

In yet another embodiment of the invention, as shown in FIG. 4, the system profiler 18 can be programmed to perform comparative processing of an explicit user profile 20 and implicit user profile 26 for providing a combined explicit/implicit user profile 32. The previously cited Ser. No. 09/666,401 teaches methods for combining explicit and implicit television viewer profiles for recommending television programming to an associated viewer.

In yet another embodiment of the invention, the system 1 typically operates to store in memory (not shown) of the system computer 4 any one or combination of explicit, implicit, and combined explicit/implicit user profiles 20, 26, and 32, respectively. Thereafter, as shown in FIG. 5, the system computer 4 is programmed to retrieve from memory a desired one of the user's profiles 20, 26, or 32, in order to conduct a Web search 34 for any meetings, such as conferences, courses, and similar events that include a substantial number of the preferences included in the collected user profile 20, or 26, or 32. The results of the system Web search 34 are then collected for providing a listing of meeting recommendations 36 to the user being serviced.

In another embodiment of the invention, as shown in FIG. 6, system collaborative filtering 38 is used for processing user profile 20, or 26, or 32, for generating a meeting recommendations list 40 for presentation to the user. The collaborative filtering 38 includes processing the user profile 20, or 26, or 32 to match the included preference information against the preference information of other users of the system 1, for generating a listing of meeting recommendations 40 based upon what other users of the system 1 have preferred. Methods for employing collaborative filtering are known in the art, and can be found at Website http://pespmcl.vub.ac.be/COLLFILT.html. Also, previously cited Ser. No. 09/953385, for “Four-Way Recommendation Method And System Including Collaborative Filtering,” filed on Sep. 10, 2001, teaches the use of a combination of implicit, explicit, feedback and collaborative filtering for providing a listing of television programs for a viewer to choose from based upon the viewer's preestablished profile of television programming interests. The teachings of these references, as previously indicated, are incorporated herein by reference to the extent that they do not conflict herewith.

With further reference to FIG. 5, and with reference to FIG. 7, the programming steps included in the software 6 for programming system computer 4 to generate meeting recommendations are shown. Specifically, as shown in FIG. 7, the meeting recommendation generation process 42 is initiated by entering step 43 for retrieving a given user's profile 20, or 26, or 32 from memory in the system computer 4. Next, step 44 is entered for searching the Web for future meetings via matching therewith selected preferences in the user profile 20, or 26, or 32. The meetings obtained are then arranged in a user desired chronology in step 45. Next, in decisional step 46, it is determined whether the user requested location specific information for all meetings uncovered. If the answer is “yes,” step 50 is entered for retrieving locations specific information for each meeting, whereafter in step 51 the system computer 4 transmits over the Internet 8 to the user computer 12 the recommended meeting list along with the location specific information. Alternatively, if in step 46 it is determined that the user did not request locations specific information for all meetings initially uncovered, step 47 is entered for sending the recommended meeting list over the Internet 8 to the user computer 12, along with a request for the user to select meetings of interest. The user then can transmit their selections via their computer 12 over Internet 8 to system computer 4, and request as indicated in step 48 that location specific information be supplied back to the user for the selected meetings. System computer 4 will then enter step 50 for retrieving location specific information for each meeting, and next in step 49 transmit this information back to the user computer 12 via the Internet 8. Note that the system computer 4 can be programmed to obtain location specific information for each meeting upon searching the Web in step 44, and retain the location specific information in memory for later use as required, or the system computer 4 can be programmed to retrieve such information only if necessary. Note that the location specific information can include but is not limited to information pertaining to each identified meeting relative to: (a) cost of travel to and from the location of the meeting; (b) a preferred lodging during the duration of the meeting; (c) preferred restaurants in close proximity to the meeting location; (d) any special discounts for meeting participants relative to travel, lodging, and meals; (e) travel directions from a given departure point to the location of the meeting; (f) cell phone provider networks available at the meeting location; and so forth. Such location specific information as enumerated, and other information that may come to mind, can be obtained via appropriate programming of the system computer 4 for searching of the Web in step 44, for presentation to a user in either one of steps 49 and 51.

With further reference to FIGS. 6 and 7, another embodiment of the invention, meeting recommendations provided in step 40 through the use of system collaborative filtering 38 can be furthered processed through use of steps 45 through 49, and/or steps 45, 50, and 51.

Although various embodiments of the present invention have been shown and described above, they are not meant to be limiting. Those of skill in the art may recognize certain modifications to these embodiments, which modifications are meant to be covered by the spirit and scope of the appended claims.

What we claim is:

1. A computerized method for providing a personalized list of future meetings per subject per user based upon the user's preferences, comprising the steps of:
obtaining a profile 20, 26, 32 listing various meeting preferences of a user;
obtaining a list of meetings 36, 40, 45 corresponding to at least a portion of the user's profile, for preparation of a recommended meetings list; and
sending the user the list of recommended meetings 51.

2. The method of claim 1, wherein said step of obtaining a profile 20 of the user's meeting preferences includes the steps of:
communicating with said user;
presenting questions to said user designed to extract the user's preferences for meetings; and
assembling an explicit user profile 20 from the user's answers 16 to the questions.

3. The method of claim 1, wherein said step of obtaining a profile 26 of the user's meeting preferences includes the steps of:
preparing a listing of various topics relative to a typical user's preferences in selecting meetings to attend or participate;
monitoring Website activities 22 of said user to obtain a listing of Websites said user contacts for information pertaining to meetings; and
assembling an implicit user profile 26 for said user by relating said topic listing to the listing of Website activities obtained from said monitoring step.

4. The method of claim 1, wherein said step of obtaining a profile of the user's meeting preferences includes the steps of:
preparing a listing of various topics relative to a typical user's preferences in selecting meetings to attend or participate;
presenting questions based upon said topic listing to said user to extract the user's preferences 16 for meetings;
assembling an explicit user profile 20 from the user's answers to the questions;
monitoring Website activities 22 of said user to obtain a listing of Websites said user contacts for information pertaining to meetings;
constructing an implicit user profile 26 for said user by relating said topic listing 16 to the listing of Website activities obtained from said monitoring step 22; and
combining said explicit 20 and implicit 26 user profiles to provide said user profile 32 for use in said step of obtaining a list of meetings.

5. The method of claim 1, wherein said step of obtaining a list of meetings includes the steps of:
connecting to the Internet 8; and
searching 44 the Web for meetings having some association with said user profile 20, 26, 32.

6. The method of claim 2, wherein said step of obtaining a list of meetings includes the steps of:
connecting to the Internet 8; and
searching 44 the Web for meetings having some association with said explicit user profile.

7. The method of claim 3, wherein said step of obtaining a list of meetings includes the steps of:
connecting to the Internet 8; and
searching 44 the Web for meetings having some association with said implicit user profile 26.

8. The method of claim 4, wherein said step of obtaining a list of meetings 36, 40, 45 includes the steps of:
connecting to the Internet 8; and
searching 44 the Web for meetings having some association with said combined explicit and implicit user profiles 32.

9. The method of claim 1, wherein said steps of sending includes the steps of:
connecting to the Internet 8; and
emailing 51 the list of recommended meetings to said user.

10. The method of claim 1, wherein said step of obtaining a list of meetings 36, 40 includes the steps:
matching 38 the preferences of said user against other users; and
generating a recommended meetings list 40 for said user based upon meetings selected by said other users having preferences similar to those of said user.

11. The method of claim 1, wherein said step of obtaining a list of meetings, further includes the step of:
retrieving location specific information 48 for each meeting obtained in response to a prior request from said user for such information, whereby such information is included with the meeting information.

12. The method of claim 1, wherein said step of sending 51 a list of meetings, further includes the steps of:
asking said user if they wish to receive location specific information for meetings selected from the list of recommended meetings;
retrieving 47 in response to a request by said user, location specific information for meetings selected by said user; and
sending 49 the location specific information to said user.

13. A computerized system for obtaining personalized lists 36, 40, 45 of future meetings per subject per user of said system 1, comprising:
a first computer 4 for said system 1 including:
a memory means for storing data, and
means for bidirectionally communicating information over the Internet 8;
a plurality of second computers 12 for a plurality of users of said system, respectively, each of said plurality of second computers 12 including:
memory means for storing data, and
means for bidirectionally communicating information over the Internet 8;
means for operating said first computer 4 to obtain a profile listing 20, 26, 32 of various meeting preferences of a user requesting a list of meetings;
means for operating said first computer 4 to obtain a list of meetings 36, 40, 45 corresponding to at least a portion of the profile 20, 26, 32 of said user; and
means for transferring a recommended meetings list from said first to said second computer.

14. The system of claim 13,wherein said means for obtaining a profile 20 further includes:
said first computer 4 and said second computer 12 of said user each being programmed for performing the following functions:
providing bidirectional communication over the Internet 8 between said first computer 4 and said second computer 12 of said user;
presenting questions, from said first computer 4 to said second computer 12, for said user to answer in relation to said user's preferences for meetings;
transmitting the answers from the second computer 12 of said user to said first computer 4; and
assembling 45 via operation of said first computer 4 an explicit user profile 20 based upon the user's answers to the questions.

15. The system of claim 13, wherein said means for obtaining a profile 26, further includes:
first programming means for programming said first computer 4 to monitor Website activities of said user to obtain a listing of Websites said user contacts for information pertaining to meetings; and
second programming means for programming said first computer 4 to assemble an implicit user profile 26 for said user by comparing said Websites to a previously prepared listing of topics of typical user's preferences in selecting meetings to attend or participate.

16. The system of claim 13, wherein said means for obtaining a user profile 32 further includes:
said first computer 4, and said second computer 12 of said user, being programmed to provide the following functions:
presenting questions to said user based upon a prepared listing of various topics relative to a typical user's preferences in selecting meetings to attend or participate, communicated from said first computer to said second computer;
assembling via said first computer 4 an explicit user profile 20 from said owner's answers to the questions as communicated from said second computer 12 to said first computer 4;
monitoring 22 via said first computer 4, the Website activities of said second computer 12 of said user to obtain a listing of Websites said user contacts for information pertaining to meetings;
constructing via said first computer 4 an implicit user profile 26 for said user by relating said topic listing to the listing of Website activities obtained from said monitoring 22 the Web search activities of said user; and
combining via said first computer 4 said explicit 20 and implicit 26 user profiles to provide an optimized said user profile 32.

17. The system of claim 13, wherein said means for obtaining a list of meetings includes:
means for programming said first computer 4 to search the Web for meetings having some association with said user profile 20, 26, 32.

18. The system of claim 14, wherein said means for obtaining a list of meetings includes:
means for programming said first computer 4 to search 44 the Web for meetings having some association with said explicit user profile 20.

19. The system of claim 15, wherein said means for obtaining a list of meetings includes:
means for programming said first computer 4 to search 44 the Web for meetings having some association with said implicit user profile 26.

20. The system of claim 16, wherein said means for obtaining a list of meetings includes:
means for programming said first computer to search 44 the Web for meetings having some association with said user profile 32.

21. The system of claim 13, wherein said means for operating said first computer 4 to obtain a list of meetings includes means for programming said first computer to:
match the preferences 20, 26, 32 of said user against other users of said system 1, whose preferences are stored in said memory means, and
generate a recommended meetings list 40 for said user based upon meetings selected by said other users who have preferences similar to those of said user.

22. The system of claim 21, wherein said means for programming said first computer 4 further includes:
means for operating said first computer to retrieve 48 location specific information for all or selected ones of the recommended meetings 36, 40.
